(19) United States
(12) Patent Application Publication
(10) Pub. No.: US 2008/0127863 A1
(43) Pub. Date: Jun. 5, 2008

(54) FLEXIBLE CONCRETE COMPOSITIONS AND METHODS FOR MANUFACTURING THEM

(76) Inventors: Mark A. Webb, Beverly Hills, CA (US); Stephen M. Hubbard, Pasadena, CA (US)

Correspondence Address: BELL, BOYD & LLOYD, LLP, P.O. Box 1135, CHICAGO, IL, 60690, US

(21) Appl. No.: 11/923,422

(22) Filed: Oct. 24, 2007

Related U.S. Application Data
(63) Continuation-in-part of application No. PCT/US2006/015601, filed on Apr. 25, 2006.
(60) Provisional application No. 60/674,412, filed on Apr. 25, 2005.

(51) Int. Cl. C04B 7/32; C04B 7/02; C04B 7/12; C04B 7/14; C04B 7/345

(52) U.S. Cl. 106/692; 106/739; 106/789; 106/638; 106/705; 106/817; 106/802; 106/814

(57) ABSTRACT

The invention concerns the addition of ammonia to cement, thereby increasing the cement's tensile strength and flexibility. More flexible cement, whether used by itself or in conjunction with other materials in cementitious compositions, is useful in a wide range of applications.

### PRIORITY CLAIM

The present application is a continuation-in-part application filed under 35 U.S.C. § 111(a) of International (PCT) application PCT/US2006/015601 filed on Apr. 25, 2006 which claims priority to U.S. Application Ser. No. 60/674,412, filed on Apr. 25, 2005, now abandoned, which are incorporated herein by reference.

### FIELD OF THE INVENTION

This invention relates to compositions of building materials. More specifically, the present invention relates to new cement compositions and methods for their preparation, whereby with the addition of ammonia, its tensile strength and flexibility increases.

### BACKGROUND OF THE INVENTION

Cement is a fine powder consisting of alumina, lime, silica, iron oxide and other compounds, which sets to a hard material after mixture with water. Cement, along with sand and stone aggregate, are combined to make concrete. Invented over 2,000 years ago by the Romans, it is one of the most widely used building materials in the world.

There are many reasons for the popularity of concrete. It is relatively inexpensive, capable of taking on the shape of a mold, has exceptionally high compression strength and is very durable. However, as a building or construction material, concrete, whether it is reinforced or not, has several shortcomings. One of these is that, due to its crystalline structure, it has relatively low tensile strength and therefore has little ability to bend.

A concrete road surface is a good example where concrete, under repeated impacts and flexing due to vehicle traffic, eventually degrades, leading to ruts and potholes. Another example are the forces generated by earthquakes, which can create large deformations in concrete structures, thereby causing their failure. Concrete that has greater tensile strength, and is thereby able to flex more without failing will result in surfaces and structures that are less susceptible to ware, cracking and catastrophic failure.

The addition of material to cementitious structures to increase their tensile strength is a recent development, with Jean-Louis Lambot's addition of metal bars and wire mesh in several concrete rowboats in 1848 being recognized as one of the first efforts. But concrete structures can require large amounts of reinforcing material, thereby significantly increasing labor and material costs. So engineers have turned to adding small metal, glass, organic polymer and other inorganic objects to concrete to reduce costs and increase the tensile strength of the material throughout the structure. In U.S. Pat. No. 213,107, T. P Hall first proposed adding small bits if metal turnings to add strength to artificial stone.

In U.S. Pat. No. 6,809,131 a combination of Portland cement, void creating additives, and 4% polymeric reinforcing fibers is used to create a light-weight, cementitious combination with exceptional flexibility. However, the efforts in prior-art to increase cement's tensile strength require the incorporation of additional mechanical material.

It is highly desirable to develop cement that chemically and inherently has greater tensile strength without requiring the addition of mechanical materials. It would be further desirable to create formulations with variable compositions to allow the manufacture of cements with different tensile and compressive characteristics, with or without the inclusion of additional materials.

### SUMMARY OF THE INVENTION

It has now been discovered that the addition of ammonia (NH₃) to cement in the range of about 0.05% to about 1%; and about 1% to 2%; and about 2% to 3%; and about 3% to 4%; and about 4% to 5%; and about 5% to 6%; and about 6% to 7%; and about 7% to 8%; and about 8% to 9%; and about 9% to 10%; and about 10% to 15%; and about 15% to 25%; and about 25% to 50% when measured as the concentration of ammonium hydroxide (NH₄OH) in the water by mass, with water to cement rations of about 0.2 to about 1.0 by mass, is found to increase the flexibility of the cement by as much as 100% or more without cracking or failure, with the optimal range being about 1% to 5%. It is thought that the increase in the tensile strength of cement is from its chemical modification, rather than through the addition of mechanical materials.

### DETAILED DESCRIPTION OF THE PREFERRED EMBODIMENT

Ammonia can be added to any known cement mixture to increase its flexibility, regardless of whether the cement is a pure paste or the composition includes additional material. This is because the cement is chemically altered by the ammonia, and this basic fact is not altered by the inclusion or exclusion of foreign material. So long as the cement paste is able to adhere to included material, the composition will reflect the increase in tensile strength and flexibility of the cement. The practice of this invention can be seen in the following examples, wherein compositions are made excluding and including additional material. In the two examples below, the deflection is calculated by the equation (B−S)/S, where “S” is the deflection of the Standard Bar without ammonia, and “B” is the deflection of the composition bar with ammonia in question. The values of deflection for each set of bars are given for the same weight for the respective set of bars.

In a preferred embodiment the mixture containing cement and ammonia is maintained in a manner that prevents loss of ammonia, as through evaporation. For example, the cement mix containing ammonia can be maintained in enclosed containers. In addition, once poured, the cement can be maintained in enclosed or covered containment, including plastic coverings, boxes and the like. Ideally, the containment is maintained until the cement cures. Preferably, the covering is maintained in place past the time when the cement hardens for as long as is practical during the curing process.

Further, the ammonia can be added to cement mixtures that contain other materials that give the resulting cement increased strength. For example, the ammonia can be added to cement mixtures that contain metal, glass, composite or other fibers or and like materials that give concrete extra strength

### Example 1

Portland cement is thoroughly mixed with water (H₂O), in a by mass ratio of water to cement of 0.21, until a uniform paste is created. The water can contain ammonia in the form of ammonium hydroxide (NH₄OH) in the concentration of 0.05% to 28% percent by mass. The paste can then be poured into a mould measuring 2 inches by 2 inches by 16 inches. It is then left to cure for at least 28 days. After curing time, its flexibility was determined by standard methods known in the art to be over 200% greater than a bar of identical cement prepared in the absence of ammonia (Standard). The variation of concentration of ammonia shows that different rations of ammonia to cement create compositions with different flexibility and tensile strength. The results are shown in Table 1. For this composition, the optimal concentration of ammonia hydroxide by mass in water is about 2 to 4 percent.

TABLE 1
INCREASE IN MAXIMUM FLEXTURE
FOR CEMENT WITHOUT MATERIAL

| Percent NH₄OH | Deflection (Percent) |
|---|---|
| 0.0 (Standard) | 0 |
| 0.05 | 5 |
| 0.75 | 73 |
| 1.25 | 145 |
| 3.5 | 286 |
| 7.0 | 106 |
| 14.0 | 75 |
| 28.0 | Failed due to bar's highly brittle nature |

### Example 2

Portland cement is thoroughly mixed with dry, washed sand in a by mass ratio of cement to sand of 0.5. Next, water (H₂O) is added and mixed until a uniform paste is created in a by mass ratio of water to cement of 0.21. The water can contain ammonia in the form of ammonium hydroxide (NH₄OH) in the concentration 0.05 to 50% by mass. The paste can then be poured into a mould measuring 2 inches by 2 inches by 16 inches. It is then left to cure for at least 28 days. After curing time, its flexibility was determined by standard methods known in the art to be over 200% greater than a bar of identical cement prepared in the absence of ammonia (Standard). The results are shown in Table 2. For this composition, the optimal concentration of ammonia hydroxide by mass in water is about 1 to 5 percent.

TABLE 2
INCREASE IN MAXIMUM DEFLECTION
FOR CEMENT WITH MATERIAL

| Percent NH₄OH | Deflection (Percent) |
|---|---|
| 0.0 (Standard) | 0 |
| 0.05 | 7 |
| 1.0 | 89 |
| 3.0 | 211 |
| 5.0 | 172 |
| 8.4 | 153 |
| 10.9 | 121 |
| 11.1 | 113 |
| 12.5 | 104 |
| 14.4 | 97 |
| 16.6 | 68 |
| 20.0 | 65 |
| 25.0 | 6 |
| 50.0 | 1 |

What is claimed is:

1. A concrete composition comprising:
cement and an aqueous ammonia solution having a concentration of about 1% to 5% when measured as the concentration of ammonium hydroxide (NH₄OH) in said water by mass; and
an aqueous ammonia solution to cement ratio by mass of about 0.2 to 1.

2. The concrete composition of claim 1 comprising at least one of a Portland cement, a silica cement, a slag cement, a pozzolana cement and an aluminous cement.

3. The concrete composition of claim 1 wherein the aqueous ammonia solution has a concentration of ammonia in the range of about 0.5% to about 50% by mass.

4. The composition of claim 1, wherein the ratios of water to concrete and said concentration of ammonia can be varied to create a composition having a desired tensile and compressive strength.

5. The composition of claim 1 further comprising additional materials selected from the group of materials (sand, rock, minerals, slag, flyash, silica fume, metal, organic polymers, inorganic polymers, and glasses).

6. A concrete composition comprising a cement prepared using ammonium hydroxide as an ingredient, wherein the cement has a deflection of about 100% to about 300% more than the same cement prepared without using ammonium hydroxide as an ingredient.

7. The concrete composition of claim 6, wherein the cement comprises a cement selected from the group of cements consisting of a Portland cement, a silica cement, a slag cement, a pozzolana cement, an aluminous cement and mixtures thereof.

8. The concrete composition of claim 6, wherein the ammonium hydroxide ingredient concentration is about 1% or more to about 15% by mass in the water component of the cement mixture.

9. The concrete composition of claim 6, wherein the ammonium hydroxide ingredient concentration is about 1% or more to about 5% by mass in the water component of the cement mixture.

10. The composition of claim 6, further comprising a material selected from the group of materials consisting of sand, rock, minerals, slag, fly ash, silica, metal, organic polymers, inorganic polymers, glass and their mixtures.

11. A method for manufacturing cement comprising:
preparing an aqueous ammonium hydroxide solution having a concentration of ammonium hydroxide in water of about 1% or more to about 15% by mass, and
preparing a mixture of the aqueous ammonium hydroxide solution to cement in a ratio of from about 0.2 to about 1.

12. The method of claim 11, wherein the cement comprises a cement selected from the group of cements consisting of a Portland cement, a silica cement, a slag cement, a pozzolana cement, an aluminous cement and mixtures thereof.

13. The method of claim 11, wherein the ammonium hydroxide ingredient concentration is about 1% or more to about 5% by mass in the water component of the cement mixture.

14. The method of claim 11, further comprising adding a material selected from the group of materials consisting of sand, rock, minerals, slag, fly ash, silica, metal, organic polymers, inorganic polymers, glass and their mixtures.
